(19) United States
(12) Patent Application Publication
(10) Pub. No.: US 2008/0265736 A1
(43) Pub. Date: Oct. 30, 2008

(54) LED REFLECTIVE SPHERICAL LAMP

(76) Inventor: Cheng-Tang Chen, Sansia Township (TW)

Correspondence Address: LEONG C LEI, PMB # 1008, 1867 YGNACIO VALLEY ROAD, WALNUT CREEK, CA, 94598, US

(21) Appl. No.: 11/739,101

(22) Filed: Apr. 24, 2007

(51) Int. Cl. H01J 7/24

(52) U.S. Cl. 313/46

(57) ABSTRACT

A LED reflective spherical lamp is disclosed. The spherical lamp comprises a transparent spherical lamp hood, a leading LED beam assembly, a linkage of the leading LED beam assembly, a heat dissipation block having good thermal conductivity and a securing base, characterized in that the leading LED beam assembly comprises a threaded connection tube, a converging lense and a conductive base board for mounting LED, and the threaded connection tube screws to a screw hole at the bottom of the transparent spherical lamp hood and the threaded connection tube extends into a tube opening of the lamp hood, overlappingly connecting the converging lense, the other end of the threaded tube is a peg tube wall for peggingly connection of a corresponding recess of the conductive base board such that the LED on the conductive base board face the converging lense, and the other end of the conductive base board mounting the LED is connected to the heat dissipation block, and then is secured with the securing base, thereby when LED is lighted, LED beams pass through the transparent lense into the lamp hood such that the entire lamp hood is lighted.

### BACKGROUND OF THE INVENTION

(a) Technical Field of the Invention

The present invention relates to a spherical lamp, and in particular a LED reflective lamp structure with low consumption of electrical energy.

(b) Description of the Prior Art

The drawbacks of the currently available light bulb are that the conventional tungsten light bulbs have to recycle for properly disposal, and therefore the cost of recycling for disposal is increasing further the glass if not handle with great care, will accidentally cause injuries. Another drawback is that the tungsten light bulb is not economical in relation to the need for energy conservation. Further, the tungsten light bulb will generate heat which may cause injuries to anyone not properly handle the bulbs.

Accordingly, it is an object of the present invention to provide a LED reflective spherical lamp which can mitigate the above drawbacks.

### SUMMARY OF THE INVENTION

The primary purpose of the present invention is to provide a LED reflective spherical lamp comprising a transparent spherical lamp hood, a leading LED beam assembly, a linkage of the leading LED beam assembly, a heat dissipation block having good thermal conductivity and a securing base, characterized in that the leading LED beam assembly comprises a threaded connection tube, a converging lense and a conductive base board for mounting LED, and the threaded connection tube screws to a screw hole at the bottom of the transparent spherical lamp hood and the threaded connection tube extends into a tube opening of the lamp hood, overlappingly connecting the converging lense, the other end of the threaded tube is a peg tube wall for peggingly connection of a corresponding recess of the conductive base board such that the LED on the conductive base board face the converging lense, and the other end of the conductive base board mounting the LED is connected to the heat dissipation block, and then is secured with the securing base, thereby when LED is lighted, LED beams pass through the transparent lense into the lamp hood such that the entire lamp hood is lighted.

Still another object of the present invention is to provide a LED reflective spherical lamp, wherein the lamp hood is made from acrylic material and the screw hole at the bottom end is a female threaded hole via the bottom end of the lamp hood.

A further object of the present invention is to provide a LED reflective spherical lamp, wherein the lamp hood is made from acrylic material and the screw hole at the bottom end is a plugged threaded tube via the bottom end of the lamp hood.

Yet still a further object of the present invention is to provide a LED reflective spherical lamp, wherein the conductive base board is made from aluminum.

Still another object of the present invention is to provide a LED reflective spherical lamp, wherein the conductive base in a circuit board having copper foil circuit on the surface thereof.

Yet another object of the present invention is to provide a LED reflective spherical lamp, wherein the heat dissipation block is body adhered with a piece of heat dissipation copper foil, and the conductive base board employs the heat dissipation copper foil for connection with the heat dissipation body.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a LED reflective spherical lamp by the present invention.

FIG. 2 is an exploded perspective view of a LED reflective spherical lamp by the present invention.

FIG. 3 is a sectional view of a LED reflective spherical lamp by the present invention.

FIG. 4 is a schematic view showing the light path of the present invention.

FIG. 5 is another preferred embodiment of the LED reflective spherical lamp of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

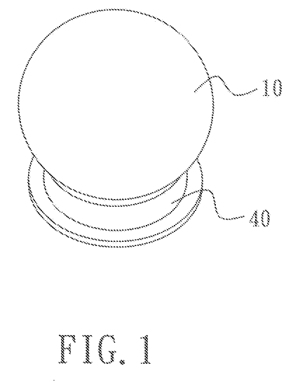

Referring to FIG. 1, there is shown a LED reflective spherical lamp comprising a transparent spherical lamp hood 10, a leading LED beam assembly 20, a linkage of the leading LED beam assembly 20, a heat dissipation block 30 and a securing base 40. The leading LED beam assembly 20 comprises a threaded connection tube 21, a converging lense 22 and a conductive base board 23 for mounting LED 24. The conductive base board 23 is made from aluminum and is a circuit board with copper foil on the surface thereof.

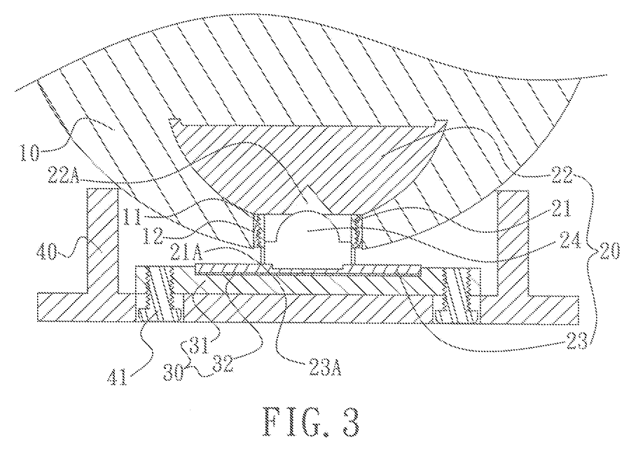

As shown in FIG. 3, the threaded connection tube 21 is screwed to a screw hole 11 at the bottom of the transparent spherical lamp hood 10. The lamp hood 10 is made from acrylic material and the bottom end of the lamp hood 10 is a hole forming the female threaded hole, which allows a plugged threaded tube 12. The threaded connection tube 21 extends into a tube opening of the lamp hood 10, overlappingly connecting the converging lense 22. The converging lense 22 is a solid lense having a semi curvature, facing the other end of the spherical center of the lamp hood 10 is a curvature face and the bottom section of the curvature face is a recess to contain the cavity 22A of LED 24. The threaded connecting tube 21 connects the other end of the lamp hood 10, and a peg connects the conductive base board 23 corresponding to the tube wall 21A of the peg of the recess 23A such that LED 24 on the conductive base board 23 extends to the threaded connection tube 21 facing the converging lense 22.

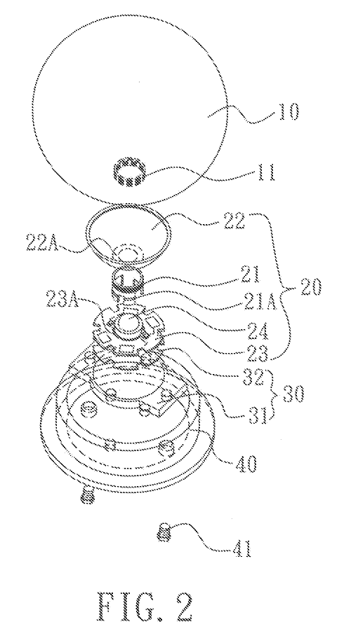

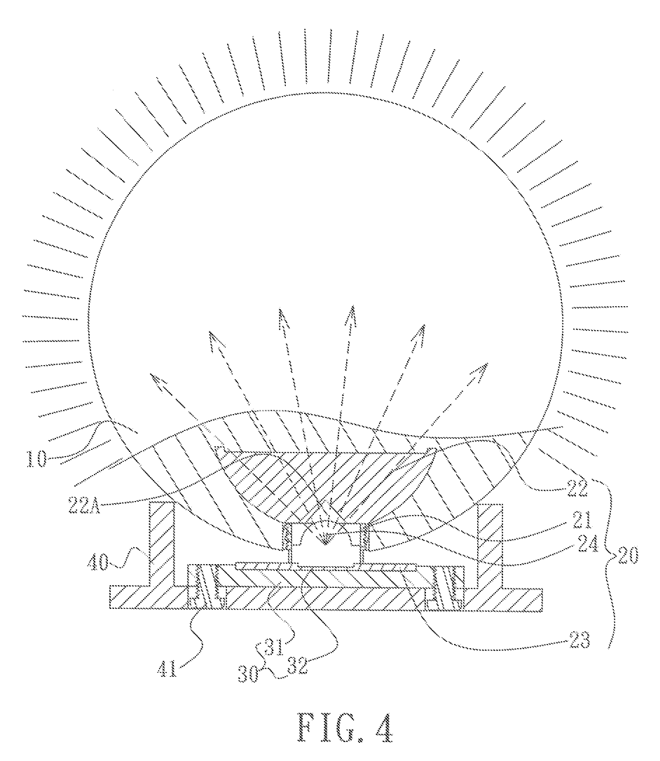

The other end of conductive base board 23 mounting the LED is connected to the head dissipation block 30, after that the securing base board 40 is mounted, and is secured using screw 41. The heat dissipation block 30 is a board made from aluminum, or as shown in FIG. 2, the aluminum heat dissipation block 31 is adhered with a piece of heat dissipation copper foil 32, and the conductive base board 25 via the heat dissipation foil 32, connects to the heat dissipation block 31. When LED 24 is lighted, as shown by the light path shown in FIG. 4, the beam of LED 24 passes through the converging lense 22 to the spherical lamp hood 10, such that the entire lamp hood 10 is lighted, and the region of illumination is enlarged. Due to the fact that LED 24 consumes lesser electricity, heat dissipation is lesser and accordingly, the entire light bulb uses lesser energy to provide brighter illumination.

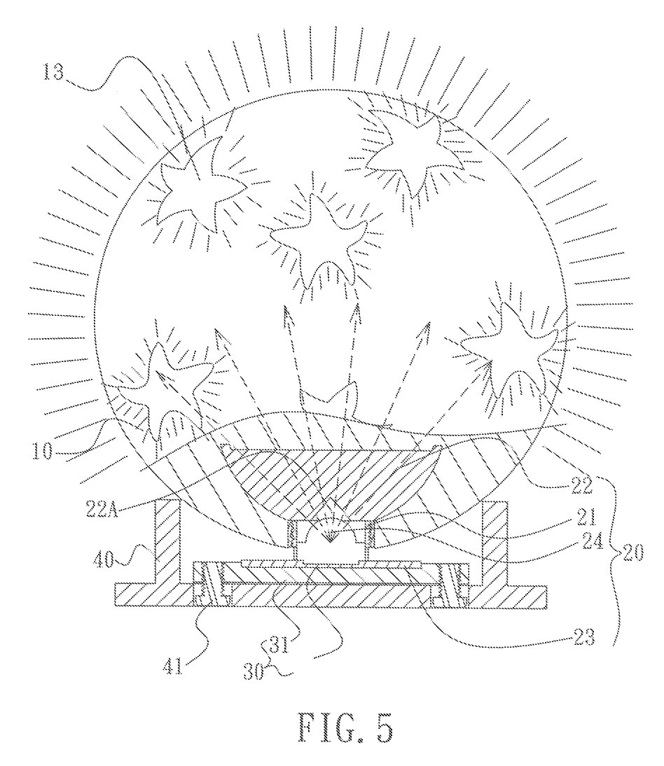

FIG. 5 shows another preferred embodiment of the present invention. The surface of the lamp hood 10 is coated or adhered with a light reflective film 13 which provides aesthetic light effect.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A LED reflective spherical lamp comprising a transparent spherical lamp hood, a leading LED beam assembly, a linkage of the leading LED beam assembly, a heat dissipation block having good thermal conductivity and a securing base, characterized in that the leading LED beam assembly comprises a threaded connection tube, a converging lense and a conductive base board for mounting LED, and the threaded connection tube screws to a screw hole at the bottom of the transparent spherical lamp hood and the threaded connection tube extends into a tube opening of the lamp hood, overlappingly connecting the converging lense, the other end of the threaded tube is a peg tube wall for peggingly connection of a corresponding recess of the conductive base board such that the LED on the conductive base board face the converging lense, and the other end of the conductive base board mounting the LED is connected to the heat dissipation block, and then is secured with the securing base, thereby when LED is lighted, LED beams pass through the transparent lense into the lamp hood such that the entire lamp hood is lighted.

2. The LED reflective spherical lamp of claim 1, wherein the lamp hood is made from acrylic material and the screw hole at the bottom end is a female threaded hole via the bottom end of the lamp hood.

3. The LED reflective spherical lamp of claim 1, wherein the lamp hood is made from acrylic material and the screw hole at the bottom end is a plugged threaded tube via the bottom end of the lamp hood.

4. The LED reflective spherical lamp of claim 1, wherein the conductive base board is made from aluminum.

5. The LED reflective spherical lamp of claim 1, wherein the conductive base in a circuit board having copper foil circuit on the surface thereof.

6. The LED reflective spherical lamp of claim 1, wherein the heat dissipation block is body adhered with a piece of heat dissipation copper foil, and the conductive base board employs the heat dissipation copper foil for connection with the heat dissipation body.

7. The LED reflective spherical lamp of claim 1, 2, 3, 4, 5 or 6 wherein the converging lense is a lense of semi curvature and is a curvature face formed at the other end of the lamp hood and the bottom section at the center of the curvature surface is a recess to contain the cavity of LED.

8. The LED reflective spherical lamp of claim 7, wherein the transparent lamp hood is adhered with a light reflective film.
